(19) United States
(12) Patent Application Publication
(10) Pub. No.: US 2004/0253418 A1
(43) Pub. Date: Dec. 16, 2004

(54) Packing material, flexible container, method of forming flexible container, method of enclosing liquid in flexible container and liquid

(76) Inventors: Mitsuru Nozue, Tokyo (JP); Akikazu Yamamoto, Tokyo (JP); Yoshimasa Nakano, Tokyo (JP); Tadaaki Kurosu, Tokyo (JP)

Correspondence Address: CONNOLLY BOVE LODGE & HUTZ LLP, SUITE 800, 1990 M STREET NW, WASHINGTON, DC, 20036-3425, US

(21) Appl. No.: 10/491,986

(22) PCT Filed: Mar. 14, 2003
(86) PCT No.: PCT/JP03/03075

(30) Foreign Application Priority Data
Mar. 26, 2002 (JP) 2002-86476

(51) Int. Cl. B32B 1/00

(52) U.S. Cl. 428/195.1

(57) ABSTRACT

There are provided a packing material capable of removing an odor, and preventing deterioration in quality of the contents, due to an odor, excellent in mechanical strength and environmental conservation, and available at a low cost, a flexible container using the packing material, a method of forming the flexible container, a method of enclosing a liquid in the flexible container, capable of removing an odor, and preventing deterioration in quality of the contents, due to an odor, and the liquid enclosed in the flexible container. The packing material (a flexible material 2, laminated film 12) has tearableness, and is a laminate or includes the laminate, the laminate comprising a heat seal layer 4 (for example, a PE film 14) having heat seal property, a gas shut-out layer 6 (for example, a CPET film 16) having gas shut-out property, and a protective layer 8 (for example, an NY film 18) having a mechanical strength, wherein the heat seal layer is exposed in the surface of the laminate. The flexible container is formed of the packing material, and a liquid is enclosed in the flexible container. With the use of the flexible container as custom-designed, the liquid is commercialized, and transportation and storage thereof is facilitated.

### TECHNICAL FIELD

The present invention relates to a packing material, container, and so forth, for use in commercialization, transportation, storage, and so forth, of a liquid such as a drinking water, pure water, and so forth, and in particular, to a packing material using a flexible material that can be torn to break seal, a flexible container, a method of forming the flexible container, a method of enclosing a liquid in the flexible container, and the liquid enclosed in the flexible container.

### BACKGROUND ART

Generally, a plastic container called a PET bottle is heavily used for commercialization, transportation, storage, and so forth, of a drinking water such as a mineral water, and other liquids. The plastic container includes “a drinking water container for use in an emergency” as disclosed in, for example, JP-A8-198231. It is pointed out, however, that this kind of plastic container is light in weight and high in safety, but is bulky and hard to handle because it is high in rigidity and keeps in a fixed shape regardless of an amount of the contents. As opposed to such a container, a flexible container in bag shape, formed of a plastic film, has been in widespread use. The flexible container is high in holding efficiency in a box or like because it undergoes variation in external shape due to fluidity of its contents, and the flexible container by itself after use is easy to handle because it is small in volume and can be optionally folded and overlaid one on top of another, thereby rendering it less bulky than the PET bottle.

As an example where a laminated film was used in the past as a packing material, there can be cited, for example, “a drinking water packing bag for long term storage and a method of manufacturing the same”, disclosed in JP-10 139074 A, “processed foodstuff in liquid state”, disclosed in JP-2000 14374 A, and so forth. In JP-10 139074 A, an antibacterial layer is formed on the surface of a base member made up of a laminate of a polyethylene film and a nylon film. Further, in JP-2000 14374 A, there is disclosed a case of packaging by use of a laminate of a plurality of layers of plastic films, providing processed foodstuff in liquid state, excellent in durability without causing deterioration and loss of fragrant constituents by rapidly absorbing oxygen gas in the foodstuff in liquid state and a head space thereof, thereby enabling long term storage.

It is pointed out, however, that a flexible container for use in commercialization, transportation, storage, and so forth, of a liquid and so forth has problems to be resolved as follows.

Firstly, in order to commercialize, transport, and store the contents such as a liquid, and so forth, using a flexible container, it is essential for the constituent material of the flexible container to give out no offensive odor at all. Removal of odor is required of a packing material itself, particularly, in the case of a commodity, such as a liquid and so forth, which quality is determined by absence of flavor and odor, and which quality is impaired by adhesion of an odor. A plurality of the flexible containers can be transported by use of a corrugated fiberboard box, and so forth, as a transportation container, however, there was a risk that if the corrugated fiberboard box, and so forth come into contact with another transportation container and other articles, in transit and during storage, odors of the corrugated fiberboard box, and so forth make ingress into the contents of the flexible container, such as a liquid state and so forth, and adhere thereto. Accordingly, there is a risk that in the case of the contents of the flexible container, such as a liquid and so forth, of which absence of favor and odor is essential, for example, an odor adhered thereto confuses a user into thinking that it has acquired a flavor, thereby impairing commercial value thereof.

Secondly, a liquid commercialized by use of the flexible container is distributed by trucks, and even with the use of the corrugated fiberboard box, and so forth, as the transportation container, there is a risk of occurrence of leakage of the contents of the flexible container such as a leakage of a liquid, and so forth if the flexible container is damaged when subjected to impact and pressure due to vibration, fall, and so on, in transit and during distribution.

Thirdly, it is necessary to enhance strength of the flexible container in order to prevent the contents from flowing out of the flexible container due to damage occurring thereto, however, if such reinforcement hinders tearableness of the flexible container, there arises then a risk that openability thereof, which is an advantage thereof, is impaired.

And, fourthly, the flexible container is convenient for waste disposal, however, if it is made of material containing environmentally hazardous substances and chlorine, it can cause environmental pollution due to flowing out of the environmentally hazardous substances after disposal, evolution of dioxin upon incineration, and so forth.

### DISCLOSURE OF INVENTION

It is a first object of the invention to provide a packing material capable of removing an odor, and preventing deterioration in quality of the contents, due to an odor, excellent in mechanical strength and environmental conservation, and available at a low cost, a flexible container using the packing material, and a method of forming the flexible container.

Further, a second object of the invention is to provide a method of enclosing a liquid in the flexible container capable of removing an odor, and preventing deterioration in quality of the contents, due to an odor, and the liquid enclosed in the flexible container.

To achieve the first object of the invention, the packing material according to the invention is a packing material having tearableness, being a laminate or including the laminate, the laminate comprising a heat seal layer having heat seal property, a gas shut-out layer having gas shut-out property, and a protective layer having a mechanical strength, wherein the heat seal layer is exposed in the surface of the laminate.

To achieve the first object of the invention, the heat seal layer of the packing material may be made of polyethylene or other resins having the heat seal property.

Further, to achieve the first object of the invention, the gas shut-out layer of the packing material may be made of ethylene-vinylalcohol resin or other resins having the gas shut-out property.

Still further, to achieve the first object of the invention, the protective layer of the packing material may be made of nylon, polyethylene terephthalate, or other resins having the high mechanical strength.

Yet further, to achieve the first object of the invention, a flexible container according to the invention is a flexible container formed of a flexible material having tearableness, comprising:

a holding part for holding a liquid and so forth, formed of the flexible material being a laminate or including the laminate, the laminate comprising; a heat seal layer having heat seal property, provided on the inner side of the laminate; a gas shut-out layer having gas shut-out property; and a protective layer having a mechanical strength;

seal parts sealing the holding part, each by bonding the heat seal layer of the flexible material; and

tear parts formed in one of the seal parts.

Further, to achieve the first object of the invention, the flexible material in the flexible container may comprise the heat seal layer on the inner side thereof, and the protective layer on the outer side thereof while the gas shut-out layer may be provided between the heat seal layer and the protective layer.

Still further, to achieve the first object of the invention, the flexible material may have a display face for printing and so forth, set on either a inner side face of the protective layer or a inner side face of the gas shut-out layer, or both.

Yet further, to achieve the first object of the invention, the method of forming the flexible container according to the invention is a method of forming a flexible container formed of a flexible material having tearableness, comprising the steps of:

forming a plurality of seal parts by bonding portions of the flexible material being a laminated film or including the laminated film, the laminate film comprising a heat seal layer having heat seal property, provided on the inner side of the laminate film, a gas shut-out layer having gas shut-out property, and a protective layer having a mechanical strength; and

forming a holding part for holding the contents including a liquid, enclosed by the seal parts.

To achieve the second object of the invention, the method of enclosing a liquid in the flexible container according to the invention is a method of enclosing a liquid in a flexible container formed of a flexible material having tearableness, comprising the treatment steps of:

forming a plurality of seal parts by bonding portions of a heat seal layer of the flexible material being a laminated film or including the laminated film, the laminated film comprising the heat seal layer having heat seal property, provided on the inner side of the laminate film, a gas shut-out layer having gas shut-out property, and a protective layer having a mechanical strength;

forming a holding part after leaving out an opening in a part of the seal parts;

charging a predetermined amount of the liquid into the holding part; and

sealing the opening of the holding part after charging the liquid.

Further, to achieve the second object of the invention, the liquid according to the invention is a liquid charged into a holding part formed of a flexible material being a laminated film or including the laminated film, the laminate film comprising a heat seal layer having heat seal property, provided on the inner side of the laminate film, a gas shut-out layer having gas shut-out property, and a protective layer having a mechanical strength; sealed with seal parts by bonding portions of the heat seal layer of the flexible material together, having tear parts formed in one of the seal parts.

With such a configuration as described, while sealing can be effected by heat-sealing of the heat seal layer having heat seal property, an odor can be blocked from make ingress into the flexible container by the gas shut-out layer having gas shut-out property., and the contents of the flexible container can be protected against damage due to perforation, and so forth, by the protective layer.

Further, with the use of the flexible container described, while the flexible material can be rendered odorless, ingress of an odor can be blocked, so that it is possible to prevent deterioration in quality of a liquid as the contents of the flexible container, due to the odor.

Thus, the packing material, the flexible container, the method of forming the flexible container, the method of enclosing a liquid in the flexible container, and the liquid, according to the invention, have the following advantageous effects:

(a) It becomes possible to provide a packing material capable of causing the contents to acquire no lingering odor, suppressing emission of an odor from the contents, preventing deterioration of the contents, due to an odor, and breaking seal with ease by tearing, excellent in mechanical strength and environmental conservation, and available at a low cost. Further, the packing can enclose a liquid such as water, and so forth, which can be thereby commercialized, transported and stored with ease.

(b) It is possible to provide the flexible container capable of causing the contents to acquire no lingering odor, suppressing emission of an odor from the contents, preventing deterioration of the contents, due to an odor, and breaking seal with ease by tearing, excellent in mechanical strength and environmental conservation, and available at a low cost.

(c) It is possible to commercialize a high quality liquid to thereby provide a highly reliable liquid since the liquid as the contents of the flexible container acquires no lingering odor, and deterioration in quality of the liquid, due to an odor from environments, can be prevented.

The above and other objects, configurations and advantages of the invention will become more apparent from the following detailed description of the preferred embodiments with reference to the accompanying drawings.

### BRIEF DESCRIPTION OF DRAWINGS

FIG. 1 is a partially cutaway perspective view of a flexible material as a first embodiment of a packing material according to the invention;

FIG. 2 is an enlarged sectional view taken on line II-II of FIG. 1;

FIG. 3 is a perspective view showing lamination treatment of the flexible material, as a first embodiment of a method of forming a flexible container according to the invention;

FIG. 4 is an enlarged sectional view showing the configuration of another flexible material;

FIG. 5 is a perspective view showing a seal treatment applied to a center seal part of the flexible material;

FIG. 6 is a plan view showing a flexible container;

FIG. 7 is a plan view showing the flexible container with water enclosed therein;

FIG. 8 is an enlarged sectional view showing the configuration of a flexible material as a second embodiment of a packing material according to the invention;

FIG. 9 is an enlarged sectional view showing the configuration of a flexible material as a third embodiment of a packing material according to the invention; and

FIG. 10 is a plan view showing another flexible container before water is enclosed therein;

### BEST MODE FOR CARRYING OUT THE INVENTION

First Embodiment

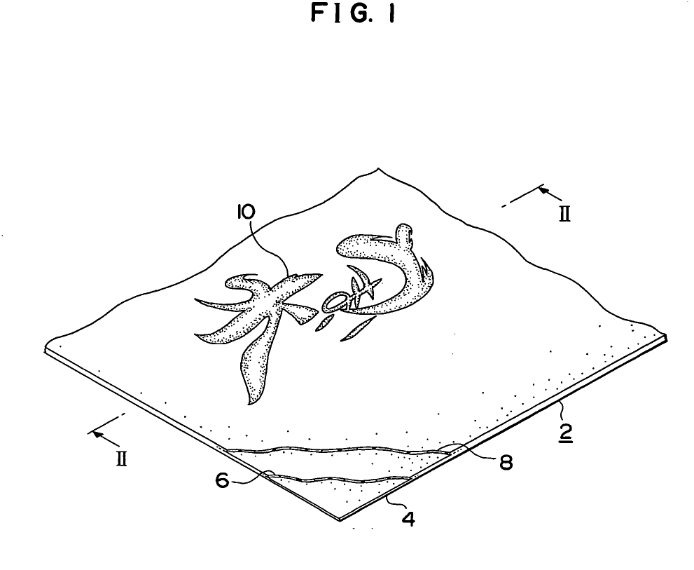

A first embodiment of a packing material according to the invention is for use in a flexible container, and so forth, for holding water, and so forth, which is the contents of the flexible container, and for the packing material, use is made of, for example, a flexible material 2 shown in FIG. 1. The flexible material 2 is a laminated film made up of a plurality of layers, and in the case of the present embodiment, the flexible material 2 is a laminate comprising a heat seal layer 4 as a base member having heat seal property, a gas shut-out layer 6 having gas shut-out property, capable of shutting out odor or the like, emitted from directions of both the top face and rear face thereof, and a protective layer 8 having suitable mechanical strength, capable of blocking leakage and so forth, of the contents. The laminate making up the flexible material 2 is formed by a dry laminating process of applying heat, pressure, and so forth to the heat seal layer 4 and the gas shut-out layer 6 with an adhesive (not shown) or adhesive resin (not shown) sandwiched therebetween and to the gas shut-out layer 6 and the protective layer 8 with the adhesive or adhesive resin sandwiched therebetween, thereby bonding those layers together.

For the heat seal layer 4, use is made of, for example, polyethylene (PE) or other resins having heat seal property, and for the gas shut-out layer 6, use is made of, for example, ethylene-vinylalcohol resin (EVOH), aluminum oxide coated crystalline polyethylene terephthalate (CPET) obtained by coating polyethylene terephthalate with an aluminum oxide, or other resins having gas shut-out property while for the protective layer 8, use is made of, for example, nylon (NY), polyethylene terephthalate (PET), or other resins having a high mechanical strength.

Accordingly, for use as the flexible material 2, there can be formed a laminate composed of, for example, “NY #25/EVOH #12/PE #45”, “PET #12/CPET #12/PE #45”, “NY #15/CPET #12/PE #45”, and so forth, respectively, through selection from those resins described above. More specifically, a flexible material “NY #25/EVOH #12/PE #45” is a laminate made up of a nylon (NY) layer 25 μm thick, an ethylene-vinylalcohol resin (EVOH) layer 12 μm thick, and a polyethylene (PE) layer 45 μm thick, a flexible material “PET #12/CPET #12/PE #45” is a laminate made up of a polyethylene terephthalate (PET) layer 12 μm thick, an aluminum oxide coated crystalline polyethylene terephthalate (CPET) layer 12 μm thick, and a polyethylene (PE) layer 45 μm thick, and further, a flexible material “NY #15/CPET #12/PE #45” is a laminate made up of a nylon (NY) layer 15 μm thick, an aluminum oxide coated crystalline polyethylene terephthalate (CPET) layer 12 μm thick, and a polyethylene (PE) layer 45 μm thick.

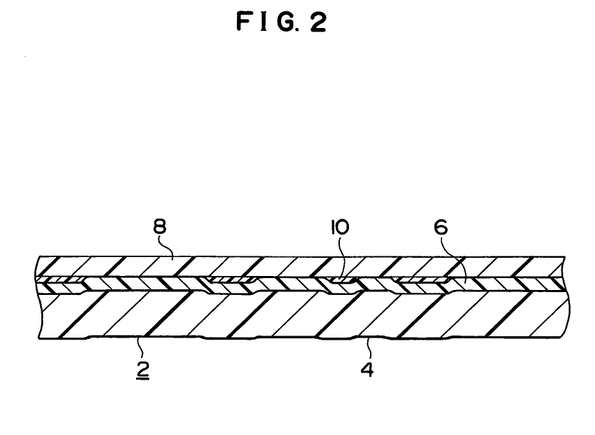

As shown in FIG. 2, the flexible material 2 has a sandwiching structure in which the gas shut-out layer 6 is sandwiched between the protective layer 8 and the heat seal layer 4, provided in the surface layer thereof, and a printing face is set on the inner face side of the protective layer 8, providing a display 10 for the contents. With the present embodiment, an identification display for water, describing “tasty water”, is shown. Thus, by providing the display 10 on the inner face side of the protective layer 8, the display 10 can be protected by the protective layer 8, and at the same time, the function of the display 10 is not impaired if a transparent material is used for the protective layer 8.

The flexible material 2, having a three-layer structure, is provided with heat seal property, gas shut-out property, and wear resistance as well as tearableness, and odorless property. In this connection, the heat seal property refers to a property capable of effecting sealing by mutual bonding and heating of the heat seal layer 4 side of the flexible material 2, and the gas shut-out property refers to a property capable of preventing lingering odor from being transferred to the contents by shutting out an odorous gas, and also shutting out odor emitted from the contents. Further, the tearableness refers to a property that when, for example, a slit is opened in a flexible material, sealing can be broken by easily tearing the flexible material starting from the slit, and the odorless property refers to a property that the heat seal layer 4 or the flexible material does not emit an odor.

Further, if a film of pure polyethylene (PE) is used for the heat seal layer 4 as the base member, even when water and so forth, as the contents of a package, come into contact with the polyethylene (PE), this will not cause the water, and so forth, to acquire odor of plastics, and so forth, to thereby render the water, and so forth, odorless, and to prevent deterioration in quality, due to the odor, while easily effecting sealing between portions of the heat seal layer 4 by bringing the portions of the heat seal layer 4 into intimate contact with each other and by heating from the side of the protective layer 8, thereby obtaining a sealing condition sufficient to be able to shut out the water, and so forth. Incidentally, the film of polyethylene (PE), for use as the base member, has an advantage of high heat seal property, however, the sealing performance thereof has a close relationship with thickness of the film, and it has been confirmed by experiments that the film with thickness of 45 μm has a high sealing performance as compared with a case of the film with thickness of 60 μm.

Further, the ethylene-vinylalcohol resin (EVOH) has high gas barrier property, however, the gas barrier property has a close relationship with film thickness, and it has been confirmed by experiments that, in the case of the film thickness being 12 μm, the gas barrier property deteriorates as compared with a case of the film thickness being 25 μm, however, this will cause no practical problem.

Further, if for the gas shut-out layer 6, use is made of, for example, the ethylene-vinylalcohol resin (EVOH), or the aluminum oxide coated crystalline polyethylene terephthalate (CPET), an external odorous gas making ingress from the side of the protective layer 8 can be shut out, so that such an odor will not reach the heat seal layer 4, thereby preventing the water, and so forth, that is, the contents of the package, from being polluted with the odor.

Furthermore, by use of nylon (NY) and polyethylene terephthalate (PET) in the protective layer 8, the mechanical strength of the protective layer 8 can be enhanced, thereby preventing the heat seal layer 4 as the base member and the gas shut-out layer 6 from being perforated with certainty. In the case of using nylon (NY) in the protective layer 8, if the nylon is wetted with water, hydrolysis and water absorption occur, thereby generating caprolactam, so that moisture absorbed sometimes reaches the gas shut-out layer 6.

In the case of using the ethylene-vinylalcohol resin (EVOH) in the gas shut-out layer 6, if the ethylene-vinylalcohol resin (EVOH) is wetted with water, it is pointed out that the barrier property of the gas shut-out layer 6 deteriorates. Accordingly, if polyethylene terephthalate (PET) is used in the protective layer 8 in a humid environment where dew condensation occurs to a product such as, for example, in the course of filling the product with water in summertime, this will cause no inconvenience as encountered in the case of using nylon (NY). However, in an environment not in a humid state, use of nylon in the protective layer 8 need not be denied because there do not occur problems such as hydrolysis and water absorption.

Then, if resins such as pure nylon, polyethylene terephthalate, ethylene-vinylalcohol resin, and so forth are used, since these do not contain environmentally hazardous substances and chlorine, there do not occur flowing out of the environmentally hazardous substances, and evolution of dioxin upon incineration, so that environmental pollution will not result.

Subsequently, there will be described hereinafter a flexible container using the flexible material as the packing material according to the invention, a method of forming the flexible container, a method of enclosing a liquid in the flexible container, and the liquid enclosed therein.

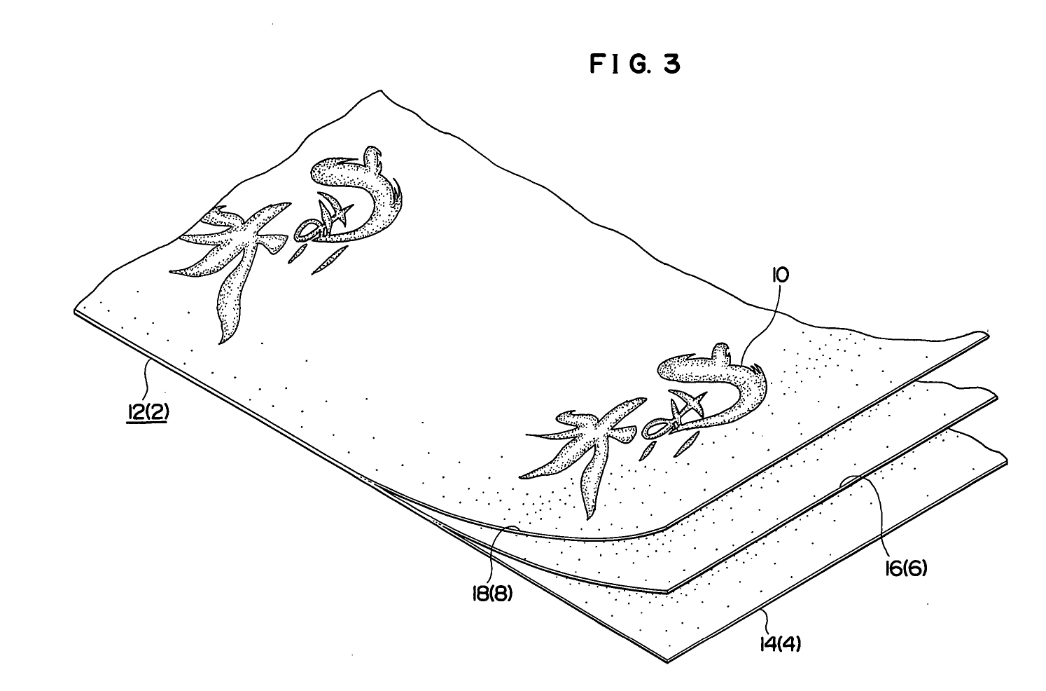

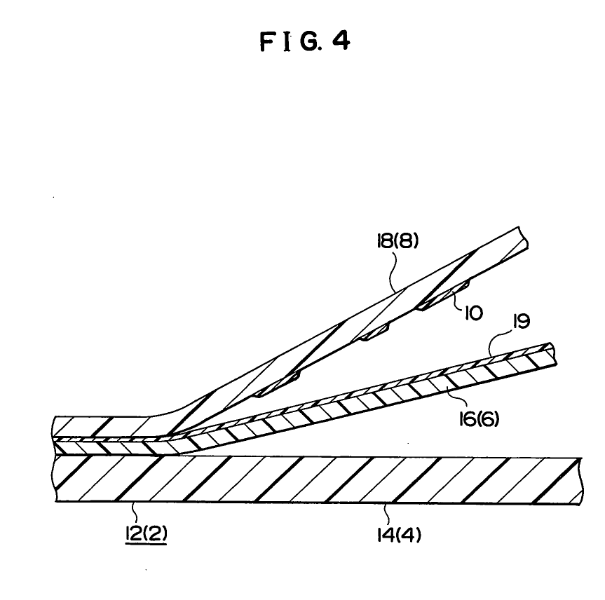

A laminate as the flexible material 2 that is the packing material, that is, for example, a laminated film 12 shown in FIGS. 3 and 4 is a single film composed of a polyethylene (PE) film 14 serving as the heat seal layer 4 as the base member, an aluminum oxide coated crystalline polyethylene terephthalate (CPET) film 16 serving as the gas shut-out layer 6, and a nylon (NY) film 18 serving as the protective layer 8. With the CPET film 16, an aluminum oxide layer 19 as a reinforcing layer for shutting out gas is formed in a surface layer thereof by coating. The aluminum oxide layer 19 is formed by applying a coating treatment to the top of the CPET film before making up the laminated film 12. Further, on the rear face side of the NY film 18, a predetermined display 10 is formed by printing.

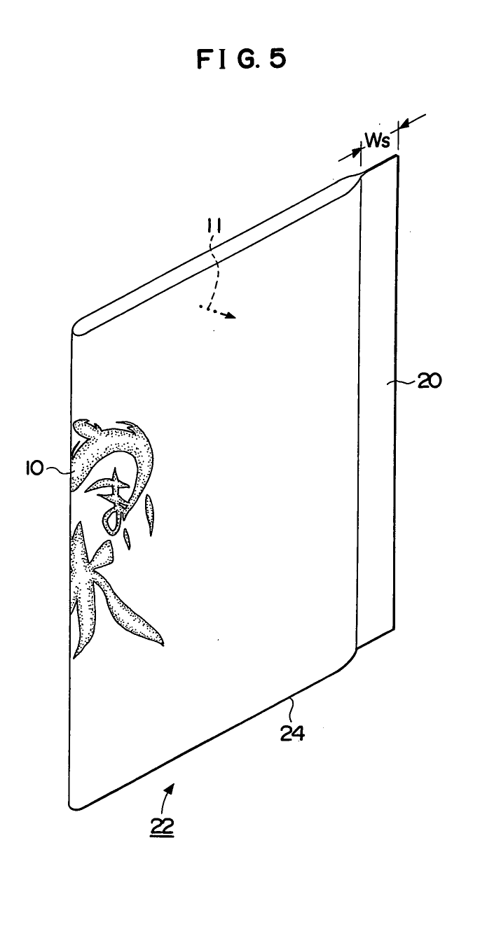

The laminated film 12 is formed in band-like shape with a predetermined width, and, for example, as shown in FIG. 5, a seal treatment is applied to a center seal part 20 by heating, thereby forming a holding part 24 of a flexible container 22 with a singe piece of the laminated film 12. In this case, because the holding part 24 is formed with the PE film 14 disposed on the inner side, the center seal part 20, on the PE film 14 side, is bonded together, and a heat treatment is applied thereto in as pressed-into-contact state inside a press-contact mould (not shown), thereby executing the seal treatment with ease. In that case, a press-bond treatment can be applied with ease by thermal compression bonding using a seal treatment machine (not shown), and with the press-bond treatment, a treatment with a high precision can be executed depending on temperature, pressure applied, and time. A seal width Ws necessary to obtain a sufficient seal force is set at the center seal part 20. In the flexible container 22, the display 10 is the identification display indicating the contents of the flexible container 22, and a display 11 is a direction display indicating a tear direction.

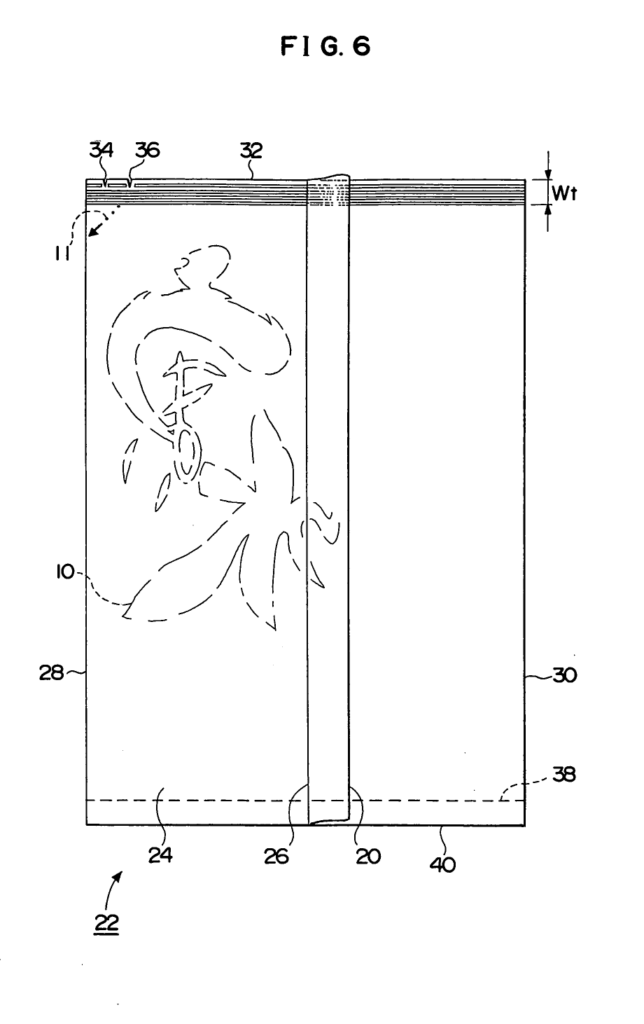

As shown in FIG. 6, with the holding part 24, while ridgelines 28, 30 are formed by setting an edge 26 of the center seal part 20 at the center of the holding part 24, the center seal part 20 is bent in one direction so as to be overlaid on the holding part 24, and a top seal part 32 is formed on the upper side of the holding part 24, thereby applying a sealing treatment thereto. In this case, as with the center seal part 20, while the top seal part 32, on the PE film 14 side, is bonded together, a heat treatment is applied thereto in as pressed-into-contact state inside the press-contact mould, thereby forming the top seal part 32 by applying a heat treatment as with the case of the center seal part 20. Further, a seal width Wt necessary to obtain a sufficient seal force is set at the top seal part 32.

Further, slits 34, 36 serving as tear parts, respectively, are formed on one corner side of the top seal part 32 to indicate seal-breaking spots corresponding to the display 11, and also to break seal with ease.

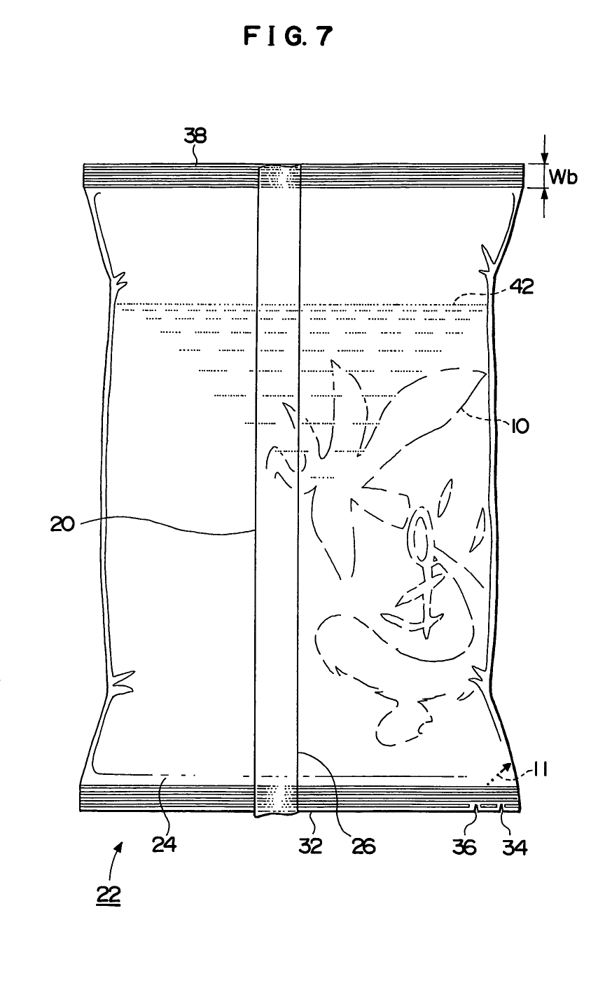

Thus, the holding part 24 sealed at two spots, that is, the center seal part 20 and the top seal part 32 makes up the flexible container 22 with an opening due to lack of a bottom seal part 38 that is yet to be formed. Subsequently, with an opening 40 side of the flexible container 22, facing upward, a predetermined amount of water 42 is charged into the holding part 24 as shown in FIG. 7 by water-charging means (not shown) while drawing off gas from the holding part 24, and as with the top seal part 32, the bottom seal part 38 is sealed by overlaying the center seal part 20, thereby completing a process of enclosing a liquid and sealing the holding part 24. In this case, a seal width Wb necessary to obtain such a sufficient seal force as in the case of the top seal part 32 is set at the bottom seal part 38.

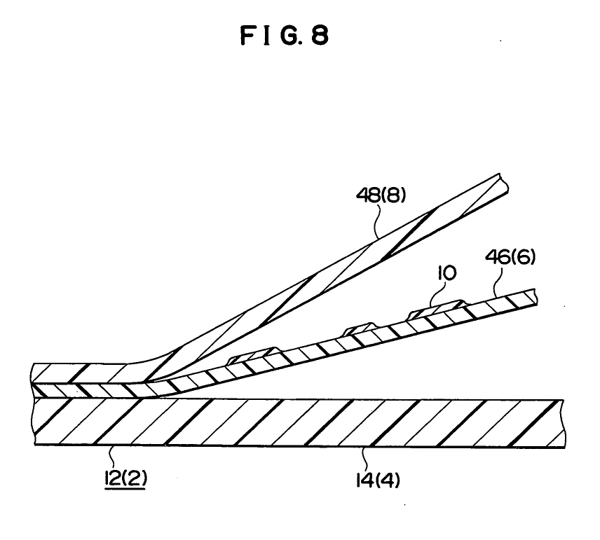

With reference to a second embodiment of the invention, the laminated film 12 can be similarly made up by use of, for example, the PE film 14 for the heat seal layer 4, an ethylene-vinylalcohol resin (EVOH) film 46 for the gas shut-out layer 6, and a polyethylene terephthalate (PET) film 48 for the protective layer 8 as shown in FIG. 8, and by bonding respective materials with each other, using the dry laminating process, and so forth, with an adhesive (nor shown) interposed therebetween. In such a case, the display 10 may be formed on the top face side of the gas shut-out layer 6.

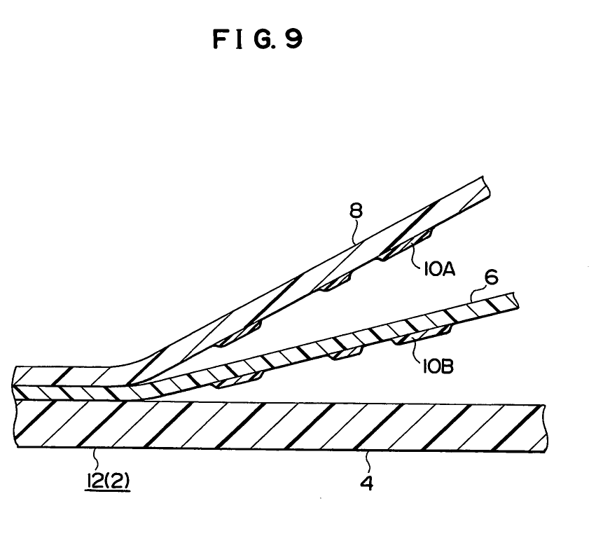

With reference to a third embodiment, as shown in FIG. 9, there may be formed a first display 10A on the rear face side of the protective layer 8, and a second display 10B on the rear face side of the gas shut-out layer 6, so that both the displays may be shown in superimposition of one upon the other, thereby enhancing a display effect by means of superimposed display.

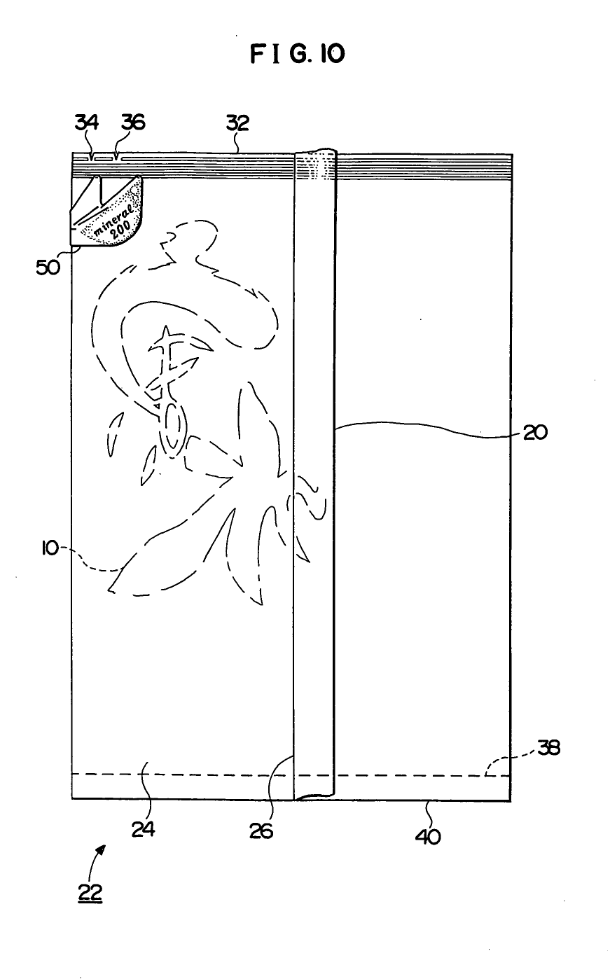

Still further, as shown in FIG. 10, in the vicinity of the slits 34, 36 of the top seal part 32, a seal-breaking guide 50 for giving a guidance for a direction of tearing from the slits 34, 36, and also for reinforcing an opening formed by breaking seal may be formed of a synthetic resin film.

Embodiments

Next, with reference to specific working examples, strength, lingering odor, and cuttable property are described hereinafter.

### WORKING EXAMPLE 1

A flexible container 22 as shown in FIG. 6 was formed with an NY #25/EVOH #12/PE #45 film made up of an NY film 25 μm thick, an EVOH film 12 μm thick, and a PE film 45 μm thick and after charging a mineral water as a flavorless and odorless water 42 into a holding part 24 of the flexible container 22, the flexible container 22 was sealed at a bottom seal part 38 thereof to be thereby rendered into such a form as shown in FIG. 7.

### WORKING EXAMPLE 2

A flexible container 22 as shown in FIG. 6 was formed with a PET #12/CPET #12/PE #45 film made up of a PET film 12 μm thick, a CPET film 12 μm thick and a PE film 45 μm thick, and after charging a mineral water as a flavorless and odorless water 42 into a holding part 24 of the flexible container 22, the flexible container 22 was sealed at a bottom seal part 38 thereof to be thereby rendered into such a form as shown in FIG. 7.

### WORKING EXAMPLE 3

A flexible container 22 as shown in FIG. 6 was formed with an NY #15/CPET #12/PE #45 film is a laminate made up of an NY film 15 μm thick, a CPET film 12 μm thick, and a PE film 45 μm thick and after charging a mineral water as a flavorless and odorless water 42 into a holding part 24 of the flexible container 22, the flexible container 22 was sealed at a bottom seal part 38 thereof to be thereby rendered into such a form as shown in FIG. 7.

### WORKING EXAMPLE 4

A flexible container 22 as shown in FIG. 6 was formed with an NY #25/CPET #12/PE #45 film is a laminate made up of an NY film 25 μm thick, a CPET film 12 μm thick, and a PE film 45 μm thick, and after charging a mineral water as a flavorless and odorless water 42 into a holding part 24 of the flexible container 22, the flexible container 22 was sealed at a bottom seal part 38 thereof to be thereby rendered into such a form as shown in FIG. 7.

With reference to not less than two of Working Examples 1 to 4, performance comparison was carried out from the viewpoint of commercialization of liquid, quality maintenance, transportability, and storability.

(1) Strength Test 1

At the strength test 1, checking was made on whether or not water leakage occurs when the flexible container 22 in pack condition, that is, bare condition is dropped from a height of 1 meter on a concrete floor 5 times (drop test 1), whether or not water leakage occurs when the flexible containers 22 housed in a corrugated fiberboard case are dropped from a height of 1 meter on a concrete floor 5 times (drop test 2), whether or not the flexible container 22 in bare condition can withstand a load of 60 kg for 1 minute (pressure test), and whetheror not damage occurs when the flexible containers 22 housed in a corrugated fiberboard case are transported between Shinjyuku and Yaizu 5 times both ways (transportation test). Results of the tests are shown in Table 1.

TABLE 1

| | container | case | |
|---|---|---|---|
| | dropped | dropped | Transportation |
| Example 1 | O. K. | O. K. | O. K. |
| (NY #25/EVOH #12/PE #45) | | | |
| Example 2 | Reject | Reject | Reject |
| (PET #12/CPET #12/PE #45) | | | |
| Example 3 | Reject | Reject | — |
| (NY #15/CPET #12/PE #45) | | | |

As is evident from the results of the tests as above, the NY #25/EVOH #12/PE #45 film was found acceptable in all the tests for the container dropped, the case dropped, and the transportation, and suitable for commercialization, transportation, and storage of the water 42. Further, it was confirmed that in the case of using an NY film for the constituent material of the surface of the flexible container, penetration resistance was found high, thereby providing excellent protection function.

(2) Strength Test 2

At the strength test 2, checking was made on whether or not water leakage occurs when the flexible container 22 in pack condition, that is, bare condition is dropped from a height of 50 cm meter on a concrete floor 2 times (drop test 1), whether or not water leakage occurs when the flexible containers 22 housed in a corrugated fiberboard case are dropped from a height of 50 cm on a concrete floor 5 times (drop test 2), whether or not the flexible container 22 in bare condition can withstand a load of 60 kg for 1 minute (pressure test), and whether or not damage occurs when the flexible containers 22 housed in a corrugated fiberboard case are transported between Shinjyuku and Yaizu 5 times both ways (transportation test). Results of the tests are shown in Table 2.

TABLE 2

| | container | case | |
|---|---|---|---|
| | dropped | dropped | transportation |
| Example 1 | O. K. | O. K. | O. K. |
| (NY #25/EVOH #12/PE #45) | | | |
| Example 2 | O. K. | O. K. | Reject |
| (PET #12/CPET #12/PE #45) | | | |

As is evident from the results of the strength test 2, the film according to Example 1 was found acceptable in all the tests while the film according to Example 2 was found rejected only in respect of transportation, but it can be said that even Example 2 has no practical problem unless excessive transportation is involved.

(2) Lingering Odor Test

At the lingering odor test, checking was made on whether or not the odors of films were sensed at a time of fabricating the flexible container 22, that is, if the films were odorless (sensory test 1), whether or not the water 42 in the flexible containers 22 acquired a lingering odor after a corrugated fiberboard as a constituent material of a corrugated fiberboard box is wetted, and the flexible containers 22 together with the corrugated fiberboard as wetted are wrapped up to be thereby stored in a constant temperature cell at 35° C. for 2 weeks (sensory test 2). In this case, whether or not there was a load due to dropping was checked. Results of the tests are shown in Table 3.

TABLE 3

| | load due to | no load due to |
|---|---|---|
| | dropping | dropping |
| Example 1 | NG | NG |
| (NY #25/EVOH #12/PE #45) | | |
| Example 2 | E | E |
| (PET #12/CPET #12/PE #45) | | |
| Example 3 | E | E |
| (NY #15/CPET #12/PE #45) | | |

As is evident from the lingering odor tests, with the film according to Example 1, a lingering odor occurred to the water 42 in the flexible containers 22, but with Examples 2 and 3, no lingering odor occurred thereto., and the quality of the water 42, at the time of charging, was maintained, obtaining excellent results in terms of the taste of the water 42 in both cases. Symbol “E” indicate the highest ranking.

Further, at the lingering odor tests, assuming that a normal usage form is storage in the refrigerator, the flexible containers 22 together with fish, meat, fermented soybeans, garlic, and so forth were concurrently stored, and whether or not the water 42 in the flexible container 22 acquired a lingering odor was checked. With the film according to Examples 2 and 3, respectively, there was found no change in terms of the taste, and excellent results were obtained.

(2) Cuttable Property Test

At the cuttable property test, checking was made on the degree of difficulty upon breaking the seal using the slit 36 formed in the flexible container 22. In this case, 6 inspectors each evaluated on a maximum 3 points, and a grade was determined on the basis of the total of those points. Results of the tests are shown in Table 4.

TABLE 4

| | cuttable | |
|---|---|---|
| | property | evaluation |
| Example 1 | 8 points | tenacious |
| (NY #25/EVOH #12/PE #45) | | feeling |
| Example 2 | 18 points | cuttable at will |
| (PET #12/CPET #12/PE #45) | | |
| Example 3 | 17 points | ″ |
| (NY #15/CPET #12/PE #45 | | |
| Example 4 | 14 points | Hard |
| (NY #25/CPET #12/PE #45 | | |

As is evident from the results of the tests, the film according to Examples 2 and 3, respectively, had the best results, however, with the film according to Example 4, there is mo practical problem.

Further, with the embodiments described in the foregoing, the laminated film 12 is cited as an example of the flexible material 2, however, it is to be pointed that the invention assumes a case where other flexible material and so forth are laminated to a laminated film and includes a packing material using a flexible material partly incorporating the laminated film, a flexible container using the flexible material, a method of forming the flexible container, a method of sealing a liquid into the flexible container, and the liquid sealed in the flexible container.

Still further, with the embodiments described, there is cited by way of example the dry lamination process whereby, for bonding the heat seal layer 4 to the gas shut-out layer 6, and the gas shut-out layer 6 to the protective layer 8, the heat seal layer 4, the gas shut-out layer 6, and so forth, on the base member side, are coated with, for example, an adhesive dissolved in a solvent, and after evaporating the solvent, those layers are laminated together by applying pressure with a heating roll, however, for bonding of those materials, use may be made of a non-sol lamination process whereby the base member sides of those materials, respectively, are coated with an adhesive (for example, a polyurethane base adhesive) after heated, without use of a solvent, and are thereby laminated together, or an extrusion lamination process whereby an anchor coat is applied to the base member sides, and a melt resin is extruded between those materials to be laminated by use an extruder to be thereby laminated together by applying pressure with a cooling roll. Thus, the packing material, the flexible container using the flexible material, the method of forming the flexible container, the method of sealing a liquid into the flexible container, and the liquid sealed in the flexible container, according to the invention, are not limited to those using the dry lamination process.

Yet further, with the embodiments described, there is described the water 42 as the contents of the flexible container by way of example, however, it is to be understood that the invention is not limited thereto, but the contents of the flexible container, according to the invention, include a drinking water, mineral water, fruit juice, vegetable juice, various kinds of liquids such as pure water, and so forth, for industrial and medical use, foodstuff such as mayonnaise, and so forth, flowing substance or solid such as ice and so forth, a mixture of those described, and so forth.

As described hereinbefore, while the preferred embodiments of the invention have been described, it is to be understood that the invention is not limited thereto, and various modifications and variations will be apparent to those skilled in the art without departing from the spirit or scope of the following claims or the invention as disclosed in the best mode of the carrying out the invention. Accordingly, such various modifications and variations should be considered to be within the scope of the present invention.

### INDUSTRIAL APPLICABILITY

The invention provides a packing material capable of causing the contents to acquire no lingering odor, suppressing emission of an odor from the contents, preventing deterioration of the contents, due to an odor, and breaking seal with ease by tearing, excellent in mechanical strength and environmental conservation, and available at a low cost. Further, the packing material is useful since it can enclose liquid such as water, and so forth, which can be thereby commercialized, transported and stored with ease, and is suitable for holding the contents such as liquid and so forth.

Still further, the flexible container, and the method of forming the flexible container, according to the invention, are useful in that, for example, it is possible to provide the flexible container capable of causing the contents to acquire no lingering odor, suppressing emission of an odor from the contents, preventing deterioration of the contents, due to an odor, and breaking seal with ease by tearing, excellent in mechanical strength and environmental conservation, and available at a low cost.

Furthermore, the method of sealing a liquid into the flexible container, and the liquid sealed in the flexible container, according to the invention, are useful in that since the liquid as the contents of the flexible container acquire no lingering odor, and deterioration in quality of the liquid, due to an odor from environments, can be prevented, it is possible to commercialize a high quality liquid, and to provide a highly reliable liquid.

1. A packing material made up of a laminated film having tearableness, being the laminate or including the laminate, the laminate comprising:
a heat seal layer having heat seal property;
a gas shut-out layer having gas shut-out property; and
a protective layer having a mechanical strength;
wherein the heat seal layer is exposed in the surface of the laminate while the heat seal layer is made of polyethylene, the gas shut-out layer is made of ethylene-vinylalcohol resin, and the protective layer is made of nylon or polyethylene terephthalate.

2. deleted

3. deleted

4. deleted

5. A flexible container formed of a flexible material having tearableness, comprising
a holding part for holding a liquid and so forth, formed of the flexible material being the laminate or including the laminate, the laminate comprising; a heat seal layer having heat seal property, provided on the inner side of the laminate; a gas shut-out layer having gas shut-out property; and a protective layer having a mechanical strength;
seal parts each with a predetermined width, sealing the holding part by bonding the heat seal layer of the flexible material; and
tear parts formed in one of the seal parts;
wherein the flexible material is made up of a single piece of the laminated film comprising: the heat seal layer of polyethylene; the gas shut-out layer of ethylene-vinylalcohol resin; and the protective layer of nylon or polyethylene terephthalate, polyethylene terephthalate, and
wherein the seal parts include a center seal part formed by folding back the laminated film, a top seal part formed by bonding the laminated film provided with the center seal part as formed for forming the holding part with the laminated film together with the center seal part, and a bottom seal part for sealing the holding part with a liquid held therein.

6. deleted

7. A flexible container according to claim 5, wherein the flexible material has a display face for printing and so forth, set on a inner side face of either the protective layer or the gas shut-out layer, or of both thereof.

8. A method of forming a flexible container formed of a flexible material having tearableness, comprising the steps of:
forming a plurality of seal parts by bonding portions of the flexible material being the laminated film or including the laminated film, the laminate film comprising a heat seal layer having heat seal property, provided on the inner side of the laminate film, a gas shut-out layer having gas shut-out property, and a protective layer having a mechanical strength; and
forming a holding part for holding the contents including a liquid, enclosed by the seal parts, wherein the laminated film comprises the heat seal layer of polyethylene, the gas shut-out layer of ethylene-vinylalcohol resin, and the protective layer of nylon or polyethylene terephthalate;
wherein the steps of forming the plurality of the seal parts and forming the holding part include the steps of forming a center seal part by folding back the laminated film, forming a top seal part in the laminated film provided with the center seal part as formed to thereby form the holding part, and forming a bottom seal part in the holding part for sealing the holding part.

9. A method of enclosing a liquid in a flexible container formed of a flexible material having tearableness, comprising the treatment steps of:
forming a plurality of seal parts by bonding portions of the flexible material being a laminated film or including the laminated film, the laminated film comprising a heat seal layer having heat seal property, provided on the inner side of the laminate film, a gas shut-out layer having gas shut-out property, and a protective layer having a mechanical strength;
forming a holding part after leaving out an opening in a part of the seal parts;
charging a predetermined amount of the liquid into the holding part; and
sealing the opening of the holding part after charging the liquid;
wherein the laminated film comprises the heat seal layer of polyethylene, the gas shut-out layer of ethylene-vinylalcohol resin, and the protective layer of nylon or polyethylene terephthalate, and
wherein the treatment steps of forming the plurality of the seal parts and forming the holding part include the treatment steps of forming a center seal part by folding back the laminated film, forming a top seal part in the laminated film provided with the center seal part as formed to thereby form the holding part, and forming a bottom seal part in the holding part for sealing the holding part.

10. A liquid charged in a holding part formed of a flexible material being a laminated film or including the laminated film, the laminate film comprising a heat seal layer having heat seal property, provided on the inner side of the laminate film, a gas shut-out layer having gas shut-out property, and a protective layer having a mechanical strength; sealed with seal parts by bonding portions of the heat seal layer together, having tear parts formed in one of the seal parts, wherein the laminated film is a single piece of laminated film comprising the heat seal layer of polyethylene, the gas shut-out layer of ethylene-vinylalcohol resin, and the protective layer of nylon or polyethylene terephthalate, and wherein the seal parts include a center seal part formed by folding back the laminated film, a top seal part formed by bonding the laminated film provided with the center seal part as formed for forming the holding part with the laminated film together with the center seal part, and a bottom seal part for sealing the holding part.

11. A flexible container according to claim 5, wherein either a single or a plurality of slits serving as the tear parts are formed in the top seal part, and the holding part is provided with a seal-breaking guide for giving a guiding for a direction of tearing from the slits and also for reinforcing an opening of the holding part, formed by breaking seal.

12. A flexible container according to claim 11, wherein the seal-breaking guide is made of a synthetic resin film.
